(19) United States
(12) Patent Application Publication
(10) Pub. No.: US 2002/0016723 A1
(43) Pub. Date: Feb. 7, 2002

(54) Information broadcasting method and device

(76) Inventors: Kazuki Matsui, Kawasaki (JP); Youji Kohda, Kawasaki (JP)

Correspondence Address: STAAS & HALSEY, Suite 500, 700 Eleventh Street, N.W., Washington, DC, 20001, US

(21) Appl. No.: 09/745,721

(22) Filed: Dec. 26, 2000

(30) Foreign Application Priority Data
Jul. 31, 2000 (JP) 2000-231022

(51) Int. Cl. G06F 17/60

(52) U.S. Cl. 705/6

(57) ABSTRACT

Method and system for readily predicting consumer behavior from services purchased on a network and putting predicted results to effective use for marketing. From terminal 3 of a souvenir shop or restaurant advertiser, advertisements for its own commodities are registered in travel agent terminal 1 of a travel broker who makes travel arrangements. Travelers, e-mail addresses of the travelers, and travel schedules are correlatively stored in the travel agent terminal 1. The travel agent terminal 1 broadcasts registered advertisements to all the travelers at optimal timing. The broadcast timing is determined by consulting the travel schedules. For example, advertisements in connection with souvenir shops in Osaka are broadcast while travelers stay in Osaka, and just before transit to Osaka.

### TECHNICAL FIELD

The present invention relates to information provision services on the Internet. More particularly, the present invention relates to new information service techniques targeted to travelers and using the Internet environment.

### DESCRIPTION OF RELATED ART

Along with the rapid popularization of the Internet in recent years, it has become the norm to shop for commodities of all kinds, book tickets of various sorts, and make travel reservations on the Internet. The individuals providing these services analyze user tastes based on purchasing histories, for marketing strategies to sell commodities strategically. In other words, what sort of commodities the users will desire and how they will next behave is predicted from analyzing the purchasing histories, according to which predictions commodities are developed and services are provided. This technique is effective for strategic marketing and is widely used.

The Internet is suited thus to gathering purchasing histories. Most noteworthy is the formula, carried out generally via Web Pages, of prompting users to user registration for making services available and assigning user IDs when registering, and thereby collectively supervising users' later purchasing activities. Nevertheless, the time and monetary burden for gathering the vast amount of data necessary to analyze, based on user IDs, purchasing histories of goods or services provided on the Internet is enormous. Sophisticated analytical knowledge such as statistics is also needed, and precise and useful analytical results are not readily obtained. Furthermore, purchasing histories and analytical results are ordinarily treated as business secrets and, apart from in-house marketing strategies, in effect are hardly used, despite the large-scale costs invested.

### SUMMARY OF THE INVENTION

An aim of present invention is, without need for sophisticated analytical results, to provide commodities or service information by which optimal advertising effectiveness is targeted to users using the Internet, and, with travelers in transit as the object, to provide at optimal timings and optimal points advertising information that the travelers concerned need, elevating the effectiveness of advertising on the travelers.

To address the foregoing issues, the present invention in essence lies in the concept of consulting a travel schedule for a specified person or plural persons and, designating communication identifiers for the specified person(s), automatically broadcasting pre-registered advertising information or reference information concerning travel-schedule dates and times or places. Put more specifically, the present invention in a first aspect provides an information broadcasting method that consults a specified person's itinerary and automatically broadcasts to the specified person's information terminal pre-registered advertising information and look-up information in connection with the dates and times and/or places concerned.

The present invention in a second aspect provides an information broadcasting method that from an information-provision service device broadcasts to travelers information in connection with travel destinations, the information broadcasting method:

A: registering in the information-provision service device communications addresses for the travelers and the travel schedule in which the travelers participate;

B: registering in the information-provision service device relevant information in connection with to-be-visited travel destinations in the travel schedule, as well as broadcasting prerequisites for broadcasting the relevant information; and

C: matching the broadcasting prerequisites for the relevant information with the travel schedule, extracting travelers who meet the broadcasting prerequisites, and broadcasting the relevant information to the extracted travelers, communications addresses according to the progress of the travel schedule.

A third aspect of the present invention provides an information broadcasting method that from travel service providers broadcasts to travelers information in connection with travel destinations, the information broadcasting method including the below noted steps A to E:

A: storing communications addresses for the travelers, travel plans in which the travelers participate, and travel-plan schedules;

B: providing travel-plan schedules to third parties other than the travel service providers or the travelers;

C: accepting from the third parties relevant information in connection with to-be-visited travel destinations in the travel plan, as well as broadcasting prerequisites for broadcasting the relevant information;

D: based on the information stored in step A, extracting travelers who meet the broadcasting prerequisites and/or travelers anticipated to meet the broadcasting prerequisites; and

E: at predetermined timings broadcasting said relevant information to the communications addresses for the extracted travelers.

Package tours arranged by travel agencies or travel planned by travelers themselves may be cited predetermined travel plans. E-mail addresses, instant messaging IDs, phone numbers, fax numbers, and IP addresses can be used as communication addresses. The communications address is not limited to being a single one per traveler.

Advertisements or commodities news, such as information on souvenir items sold by third parties and restaurants, lodging information, and information on highlights may be cited as relevant information. The relevant information may in addition to advertisements also include advertisement IDs (ad IDs hereinafter) or identification numbers such as barcodes for identifying advertised items. Thus when a traveler visits a store, advertised discount services can be implemented on the basis of the ad ID or barcode.

Designation of travel plans themselves, and designating travel destination region, travel period, traveler's age, sex, occupation and family makeup may be cited as broadcasting prerequisites. For example, if a broadcasting region “Osaka” and broadcasting date “Jul. 3, 2000 to Jul. 5, 2000” are designated, advertisements are broadcast to travelers in Osaka in a period of Jul. 3, 2000 to Jul. 5, 2000. Advertisements may be broadcast beforehand to a traveler who is anticipated to be in a designated region in a designated period. Broadcasting of relevant information such as advertisements may be broadcast automatically or on a traveler's demand.

Broadcasting may be performed before a travel or transit as well as during travel that meets broadcasting prerequisites.

A fourth aspect of the present invention provides an information broadcasting method according to the third aspect, that correlatively stores predetermined personal information and the above-mentioned communication address. This method provides predetermined detailed information that traveler-identifiable information is excluded from the above-mentioned personal information of a traveler who is expected to satisfy the above-mentioned broadcasting prerequisites for the above-mentioned third party if the above-mentioned broadcasting prerequisites are designated prior to the registration of the above-mentioned relevant information.

Name, address, generation, sex, hobby, occupation, credit card information, etc. can be cited as examples of personal information. It is conceivable that of such information, things other than name, address, and credit card information can be disclosed to others. Consequently such information is provided to be a help of effective advertisement provision. Detailed information may be provided on a Web Page where broadcasting prerequisites are inputted or be broadcast by e-mail every predetermined period.

A fifth aspect of the present invention provides an information broadcasting method according to the third aspect, wherein the above-mentioned communication address is changed according to a schedule of a travel plan.

For example, a communication address is changed to a fax number of a stay hotel if a destination is out of mobile phone service area.

A sixth aspect of the invention is an information broadcasting method according to the third aspect, wherein the designation of receiving conditions including need for broadcast of the above-mentioned relevant information and/or type of relevant information to be broadcast is accepted from the above-mentioned traveler, and the above-mentioned relevant information is broadcast before the above-mentioned receiving conditions correspond to the above-mentioned broadcasting information.

Broadcast is not performed for a traveler who designates broadcast of relevant information as unnecessary even if the traveler meets broadcasting prerequisites. Even if the broadcast is “necessary,” broadcasting is not carried out if the information is not a designated type of information. As types of relevant information, drinking and eating information, souvenir information, good-point information, theatergoing information, etc. can be cited.

A seventh aspect of the present invention provides an information broadcasting method according to the third aspect, wherein billing is performed according to a count of relevant information broadcasts and/or broadcast data volume.

Billing is performed according to the advertisement broadcast count and the advertisement data volume. A traveler who actually browsed the advertisements can be billed.

An eighth aspect of the present invention provides an information broadcasting method according to the third aspect, wherein predetermined ticket is detected being used during the above-mentioned travel plan in progress and alteration in a schedule of the above-mentioned travel plan is detected according to a use record of the above-mentioned ticket.

With this, for example, a ticket that was not used can be canceled or a traveler who missed a train can be notified of an substitute ticket.

A ninth aspect is an information broadcasting method according to the eighth aspect, wherein travelers satisfying the above-mentioned broadcasting prerequisites and/or travelers being expected to satisfy the above-mentioned broadcasting prerequisites are extracted according to the above-mentioned changed schedule.

For example, if a train ticket is not used, it is no use broadcasting advertisements about a scheduled destination because the traveler does not move to the destination. To avoid the waste, the extraction of travelers is made to reflect change of the schedule.

A tenth aspect of the present invention provides an information broadcast device broadcasting information on a destination from a travel service provider to a traveler, which comprises storage means, acceptance means, extraction means, and broadcast means.

Storage means correlatively stores a communication address of the above-mentioned traveler, a travel plan the above-mentioned traveler participates in, and a schedule of the above-mentioned travel plan. Provision means provides a schedule of the above-mentioned travel plan for a third party other than the above-mentioned travel service provider or the above-mentioned traveler. Acceptance means accepts relevant information on a destination to be visited in the above-mentioned travel plan and designation of broadcasting prerequisites to broadcast the above-mentioned relevant information from a third party. Extraction means extracts a traveler who meets the above-mentioned broadcasting prerequisites and/or a traveler who is expected to satisfy the above-mentioned broadcasting prerequisites according to the above-mentioned stored information. Broadcast means that broadcasts the above-mentioned relevant information to a communication address of the above-mentioned extracted traveler at predetermined timing.

These devices are used for host terminals of the travel service providers executing the above-mentioned means.

An eleventh aspect of the present invention provides an information broadcasting method broadcasting information on a destination from a travel service provider to a traveler, which comprises the following steps A to D:

A: correlatively storing a communication address of the above-mentioned traveler and a travel plan the above-mentioned traveler participates in;

B: providing a schedule of the above-mentioned traveler for a third party;

C: accepting designation of advertisements for a traveler who participates in the above-mentioned travel plan from a third party;

D: broadcasting the above-mentioned advertisements to a communication address of the above-mentioned traveler who participates in the above-mentioned travel plan at predetermined timing.

This method is utilized in travel agents' servers. For example, an e-mail address of a traveler is obtained in advance and is used as a traveler ID. A third party refers to the schedule of the travel plan and knows where and when the traveler comes and registers advertisements suitable to the travel plan in the server. The server broadcasts the advertisements to the participants of the travel plan one week before the travel's start date or every time they move.

A twelfth aspect of the present invention provides a recording medium storing a program for executing an advertisement broadcast method used in an advertisement device connected to multiple user terminals, multiple advertiser terminals, and multiple travel agency terminals via a network. The program executes the following processes A to F:

A: providing for a user terminal or travel agency terminal a screen for inputting information on application for a travel and/or information on receiving conditions of advertisement information;

B: correlatively storing a user, a travel schedule, and receiving conditions of advertisements in a storage device based on application information sent from a user terminal or a travel agency terminal;

C: providing for said advertiser terminal a screen for inputting advertisement data broadcast to travelers and broadcasting prerequisites;

D: storing advertisement data to be broadcast to a traveler and broadcasting prerequisites that are sent from an advertiser terminal in a storage device;

E: comparing receiving conditions of a traveler with broadcasting prerequisites of an advertisement and identifying a corresponding traveler; and

F: sending relevant advertisement data to an identified traveler.

### BRIEF DESCRIPTION OF THE DRAWINGS

FIG. 1 is an overall configurational diagram of an information broadcasting system according to a first embodiment of the present invention;

FIG. 2 is a conceptual explanatory diagram of a schedule DB: (a) Plan Table, and (b) Ticket Table;

FIG. 3 is a conceptual explanatory diagram of a traveler DB;

FIG. 4 is a conceptual explanatory diagram of a broadcasting information DB;

FIG. 5 is an explanatory diagram showing flow in a main process;

FIG. 6 is an explanatory diagram showing flow in a ticket process;

FIG. 7 is an example of data included in ticket use notification;

FIG. 8 is a flowchart showing flow of an advertisement broadcasting process that a travel agent's terminal carries out;

FIG. 9 is a flowchart showing flow of a substitute schedule notification process performed by a travel agent's terminal;

FIG. 10 is a flowchart showing flow of a customer information broadcast process performed by a travel agent's terminal;

FIG. 11 is an example of a personal information recording screen on a Web Page;

FIG. 12 is an example of travel application screen on a Web Page;

FIG. 13 is an example of an advertisement registration screen on a Web Page;

FIG. 14 is an example of a screen for setting detailed broadcasting prerequisites; and

FIG. 15 is a display example of an advertisement on a mobile phone.

### DETAILED DESCRIPTION OF THE PREFERRED EMBODIMENTS

### Overview of the Invention

In the present invention, user IDs are associated with the user's schedules. With certain kinds of commodities such as transportation tickets or tours, the schedules bind purchaser's behavior for a set period in the future. Accordingly, user's behavior for a set period in the future is readily predicted by associating user IDs, commodities, and schedules in connection with the commodities.

For example, travel plan participants who have made reservations via the Internet behave in accordance with the travel plan schedule. That is, the participants gather on a certain day in a predetermined meeting, travel using prearranged transportation facilities, stay for set time periods in determined places and go about activities such as regional shopping or dining within fixed-period determined limits.

These sorts of travel schedules are high use-value marketing information for third parties apart from travel agents. Souvenir shops and restaurants that are travel destinations are informed in advance by travel agents of travel schedules, and prepare, and record in the travel agents, servers, advertisements fitting the schedules. In line with the schedules, the travel agents broadcast the recorded advertisements to the travelers. Travelers at travel destinations and travelers who are about to go on a trip can be informed of travel-destination souvenir and restaurant information at timings suited to their schedules.

Third parties, informed by travel agents not only of travel schedules, but of travelers' age bracket and family makeup, hobbies and the like as well, can advertise all the more appropriately to the travelers. Presumably, travelers would not mind that the foregoing detailed information is provided to third parties, as long as the information does not specify individual persons.

Furthermore, this system not only can confer marketing opportunities on third parties, but also can bring added benefits to travel agents and travel plan participants. Travel agents can collect remuneration from third parties for use of schedules. Travel plan participants might receive travel rate discounts reflecting that share, and otherwise can easily amass enriched regional information in connection with travel destinations.

### First Embodiment

The following specifically describes an information broadcasting system according to the present invention with embodiments exemplified. In the present invention, users connecting to terminals of travel agencies, in other words, customers of the travel agencies are referred to as travelers whether on their trip or not.

(1) Configuration

(1-1) Overall Configuration

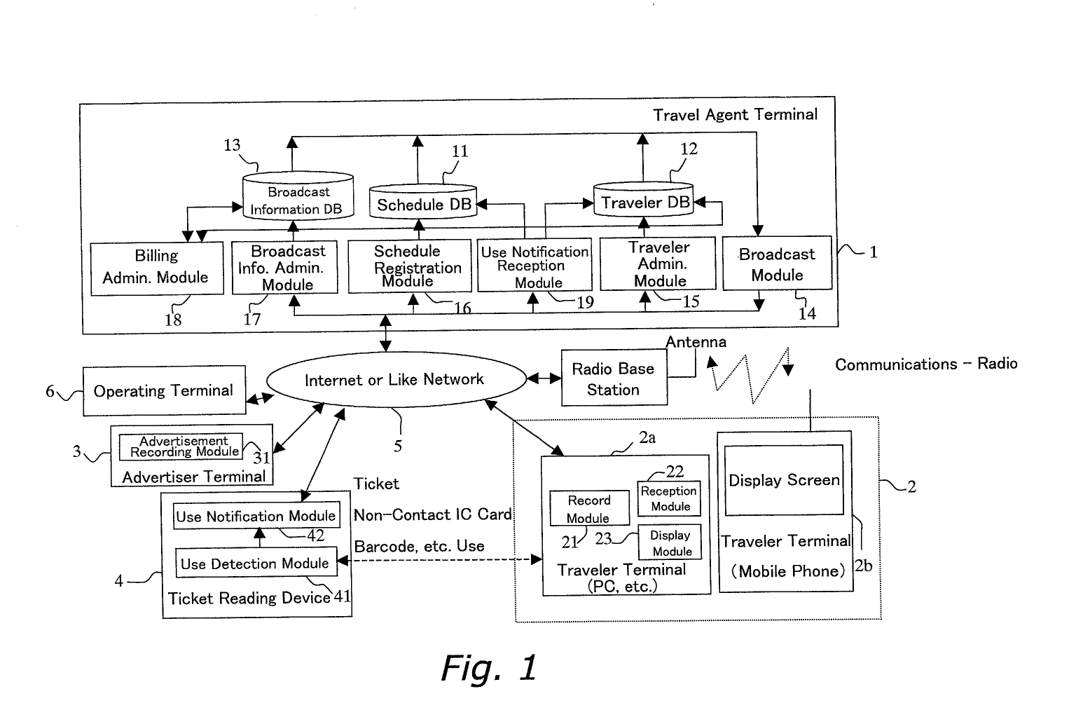

FIG. 1 is an overall configuration diagram of an information broadcasting system according to the first embodiment of the present invention. In this system, travel agent terminal 1, traveler terminal 2, advertiser terminal 3, and ticket-reading device are connected to network 5 such as the Internet. Furthermore, operation terminal 6 operated by operators of the travel agencies is connected to the network 5.

The travel agent terminal 1 administrates information required in planning, arranging and carry out package tours and personal travel. The travel agent terminals that implement information provision services in the present invention are not only terminals provided each travel agent, but also may be a terminal for implementing the services of the present system wherein a plurality of travel agent terminals are connected to unite a plurality of travel agents. As traveler terminals 2, there are terminal 2a used by traveler-to-be users in their homes, and on-the-go terminal 2b used at travel destinations. For example, a user accesses a Web Page with a desktop PC or notebook PC in his/her home and performs user registration or makes travel reservations. At his or her destination, the user receives advertisements with a mobile terminal such as a mobile phone, PHS (Personal Handyphone System™, the Japanese counterpart to PCS—Personal Communications Service—in the United States), or PDA (Personal Digital Assistant). The on-the-go terminal is connected to the Internet via a predetermined radio base station.

(1-2) Configuration of Travel Agency Terminal

The travel agent terminal 1 manages traveler information and travel plans and accepts advertisements of travel plans and user registration on a Web Page. Furthermore, the travel agent terminal 1 broadcasts souvenir or restaurant advertisements according to travel schedules. To broadcast such advertisements, the travel agent terminal 1 has schedule database (DB) 11, traveler DB 12, broadcast information DB 13, broadcast module 14, traveler administration module 15, schedule registration module 16, broadcast information administration module 17, billing administration module 18, and use notification reception module 19.

In the schedule DB, travel plans that are sold by travel agencies are stored. In the traveler DB 12, traveler information and information on travel plans/packages for which travelers have applied are stored. In the broadcast information DB 13, advertisement information and advertisements that advertisers would like to broadcast are stored. These databases are described later.

The broadcast module 14 broadcasts broadcasting information such as advertisements to the traveler terminals according to broadcasting prerequisites registered in the broadcast information DB 13. The traveler management DB 15 accepts registration of personal information from travelers. The schedule registration module 16 accepts travel reservations from travelers. The broadcast information administration module 17 accepts registration of information on advertisers, registration of advertisements (broadcasting information), and broadcasting prerequisites of the advertisements and registers them in the broadcast information DB 13. The billing administration module 18 calculates billing amount according to count and data volume of broadcasting information, and performs an account settlement process. The use notification reception module 19 receives the use notification of a ticket from the ticket-reading device 4 and updates the schedule DB 11 and the traveler DB 12.

(1-3) Traveler Terminal

In the traveler terminal 2, reception module 22 for receing information from travel agents, a display module 23 for displaying received information, and a record module 21 for recording predetermined information and sending it to the travel agent terminal 1 are installed. The record module 21 need not be in the on-the-go terminal 2b. In this example, these functions are realized by a browser. Travelers browse information such as travel plans provided by the travel agent terminal 1 on a Web Page with a browser. Registration of user information or registration of travel applications is carried out by input into a predetermined form on the Web Page.

In this example, e-mail devices and browsers are installed on portable terminals among the traveler terminals 2, such as mobile phones, used by travelers at travel destinations. The traveler accepts the URL of an advertisement by e-mail and refers to contents of the broadcast advertisement with the browser.

(1-4) Advertiser Terminal

The advertiser terminal 3 is used by souvenir shops or restaurants that would like to broadcast advertisements to travelers (hereinafter referred to as advertisers). This terminal 3 has advertisement recording module 31 for recording in the travel agent terminal 1 information concerning advertisers, as well as for registering advertisements in the travel agent terminal 1. This function is realized by a browser. Advertisers access a Web Page for registering advertisers and broadcasting information with the browser, input predetermined data in the format on the Web Page, and send the data to the travel agent terminal 1.

(1-5) Ticket-Reading Device

The ticket-reading device 4 has a use detection module 41 that detects the use of tickets and a use notification module 42 for notifying the travel agent terminals of tickets that have been used. The ticket-reading device 4 is installed on automatic ticket checkers in a station or check-in counters in an airport.

(1-6) operation Terminal on Travel Agency End

The operation terminal 6 is used by operators inputting schedules or travel plans.

(2) Database Information

(2-1) Schedule DB

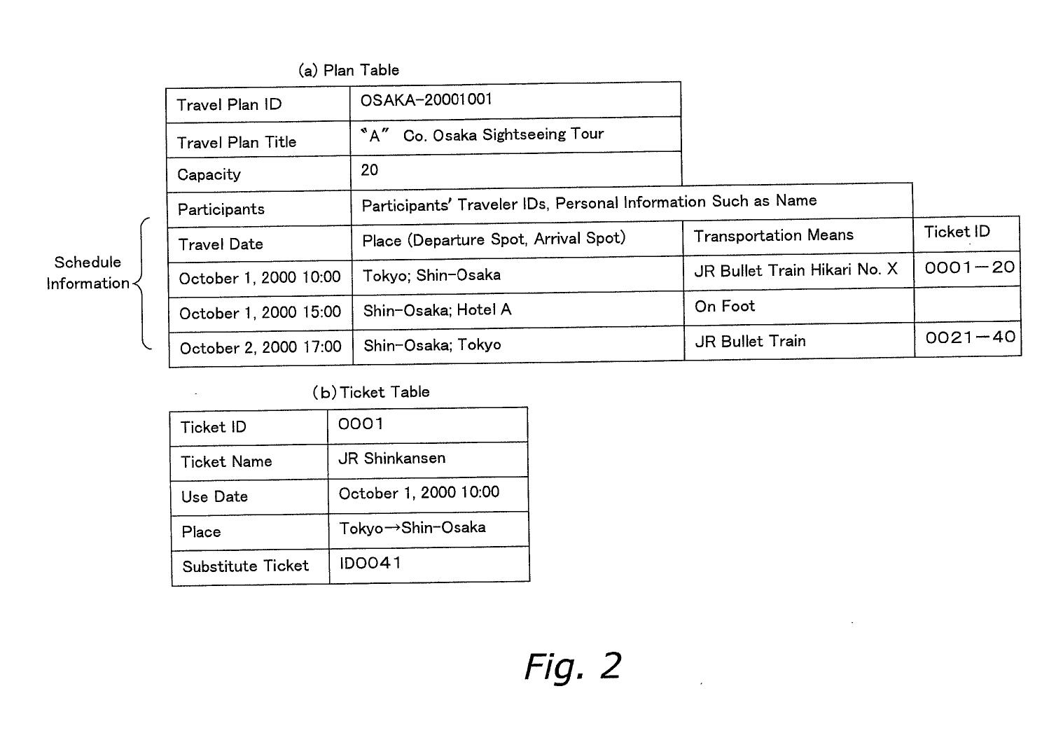

FIG. 2 shows a conceptual explanatory diagram of information stored in the schedule DB 11. In schedule DB 11, as illustrated, a plan table and a ticket table are stored. In the plan table in FIG. 2 (a), information on travel plans that are arranged by travel agencies is stored. In this example, “travel plan ID,” “travel plan title,” travel plan “capacity,” “participants,” and a predetermined schedule are stored.

“Travel plan ID” is identification information for identifying a travel plan.

As “travel plan title,” ordinarily a name is stored that indicates plainly what sort of plan each of the travel plans is.

As “participants,” at least a traveler ID of participants is stored. Predetermined personal information such as a name other than the traveler ID may be stored.

As schedule information, information for identifying a schedule of travel plan is stored. In FIG. 2 (a), “move date,” “place,” “transportation,” and “ticket ID” are stored all together. For example, travel by “JR Bullet Train Hikari No. X” bound from “Tokyo” to “Shin-Osaka” and the bullet train ticket are ticket ID “00001-20.”

In the ticket table of FIG. 2 (b), predetermined information on tickets is stored. In this example, “ticket name,” “use date,” “place” and “substitute ticket” are stored for each “ticket ID” for identifying tickets. For example, a ticket with a ticket ID “0001” is a ticket of JR Bullet Train and a ticket bound from Tokyo to Shin-Osaka on Oct. 1, 2000. As its substitute ticket, a ticket with ID “0041” is secured. The present system may be such that not only are substitute tickets secured beforehand, but also so that whereupon arrangements are made when a situation in which they are needed has arisen, their IDs are established.

(2-2) Traveler DB

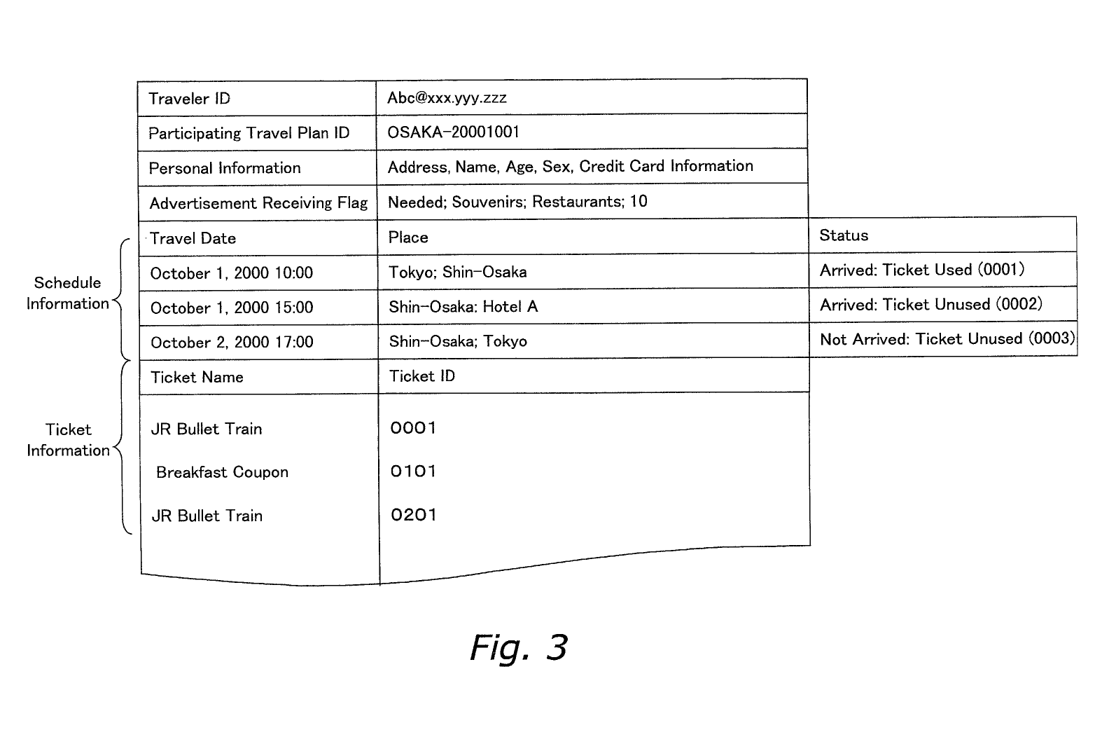

FIG. 3 is a conceptual explanatory diagram of information stored in the traveler DB 12. In this database, personal information and, if any, a travel plan scheduled to participate in are stored for each user ID. In this example, “traveler ID,” “participating travel plan,” “personal information,” “advertisement flag,” predetermined schedules, and “ticket information” are described.

“Traveler ID” is identification information for the travel agent terminal 1 to identify a traveler. It is possible to set this system's independent identification information. However, a mobile phone number or an e-mail address can be used as a traveler ID. In FIG. 3, the e-mail address of a traveler is used as the traveler ID. By using the e-mail address as the traveler ID, the traveler ID can be used as a destination address for broadcasting advertisements.

In “participating travel plan ID,” an ID of a travel plan the traveler applied to participate is stored.

In “personal information,” items such as name, address, sex, hobby, occupation, family structure, and credit card information are stored. In credit card information, credit card type, card number, and “good through” that are necessary for account settlement on a network are stored.

In “advertisement receiving flag,” receiving conditions of advertisements are described. For example, whether to receive an advertisement broadcast via the travel agent terminal 1 is described. Types of advertisements preferred to be received and the upper limit to a receiving count can be also identified. In this example, the traveler hopes to receive up to ten advertisements of souvenir information and restaurant information on each day.

As schedule information, “travel date,” “place,” and “status” are stored all together. In “travle date” and “place,” contents similar to schedule information of travel plan participated in are described. In “status,” whether travelers have arrived at a place or whether tickets have been used or canceled, for example, are stored.

As ticket information, “ticket name” and “ticket ID” are stored all together. Which ticket is allocated to which traveler is thereby specified.

(2-3) Broadcasting information ID

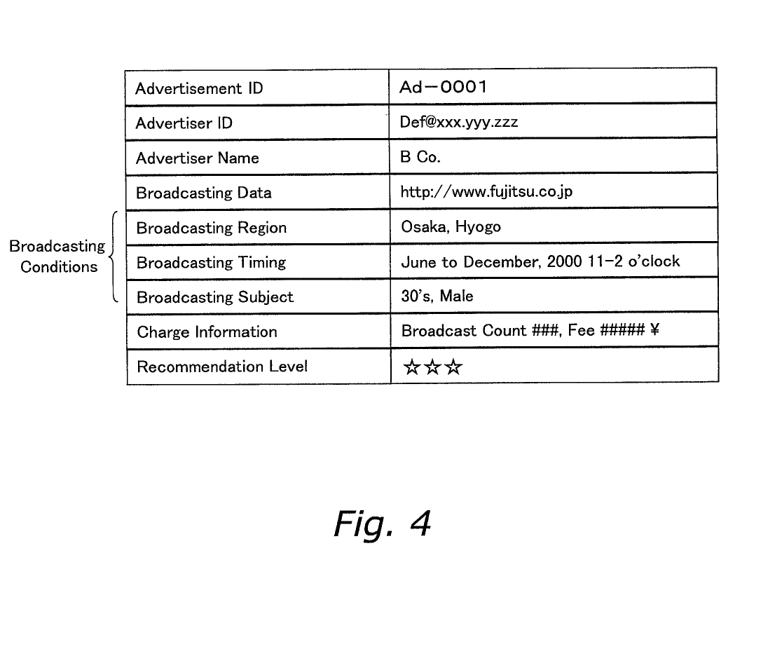

FIG. 4 is a conceptual explanatory diagram of information stored in the broadcast information DB 13. In the broadcast information DB 13, information on advertisers and their advertisements are stored. Incidentally, an address of advertisement contents may be stored instead of advertisement contents in the broadcasting DB.

In this figure, “ad ID,” “advertiser ID,” “advertiser name,” broadcasting data,” predetermined broadcasting prerequisites, “billing information,” and “recommendation level” are stored in the broadcasting DB.

“Ad ID” is identification information for the travel agent terminal 1 to identify advertisements. Travel agencies or each advertiser may grant the ad IDs.

As “Advertiser ID,” information that enables advertisers to be identified such as an e-mail address and a phone number is stored. Of course, identification information specific to the present system may be provided and utilized as the advertiser ID.

In “advertiser name,” a name of an advertiser or a company name is described.

In “broadcast data,” advertisement contents and addresses of the advertisement contents such as URLs are stored. Advertisement contents are files in the HTML format, text data, image data, sound data, etc., and not particularly limited. The advertisement information may also include ad ID for identifying advertisements or identification numbers, e.g. barcodes, for identifying advertised items. Wherein travelers visit a shop, advertised discount services and the like can be readily implemented on the basis of the ad IDs and barcodes.

As broadcasting prerequisites, “broadcast region,” “broadcast timing,” and “broadcast object” are stored in FIG. 4. These are designated by an advertiser and their combination determines broadcasting prerequisites. In “broadcast region,” regions to which an advertiser would like to broadcast advertisements are stored. In “broadcast timing,” timing when the advertiser would like to broadcast the advertisement is stored. In “broadcast object,” attributes of a traveler to which the advertiser would like to broadcast data such as age, sex, and family structure are described. Incidentally, travel plan ID, which is not shown in the figure, can be one of the broadcasting prerequisites.

In “billing information,” for example, billing amount based on the number of broadcast advertisements or the amount of broadcast data is described.

“Push level” is information set by travel agency; the push level of an advertised item is denoted by the number of asterisks.

Each database can store various information other than the above-described information according to need.

(3) Process Flow

The following describes the overall process flow of the system with reference to the drawings. This information broadcasting system chiefly performs (1) main process and (2) ticket process. The main process broadcasts registered advertisements to travelers. The ticket process accepts ticket use notification and makes schedules reflect the use notification.

(3-1) Overall Process Flow

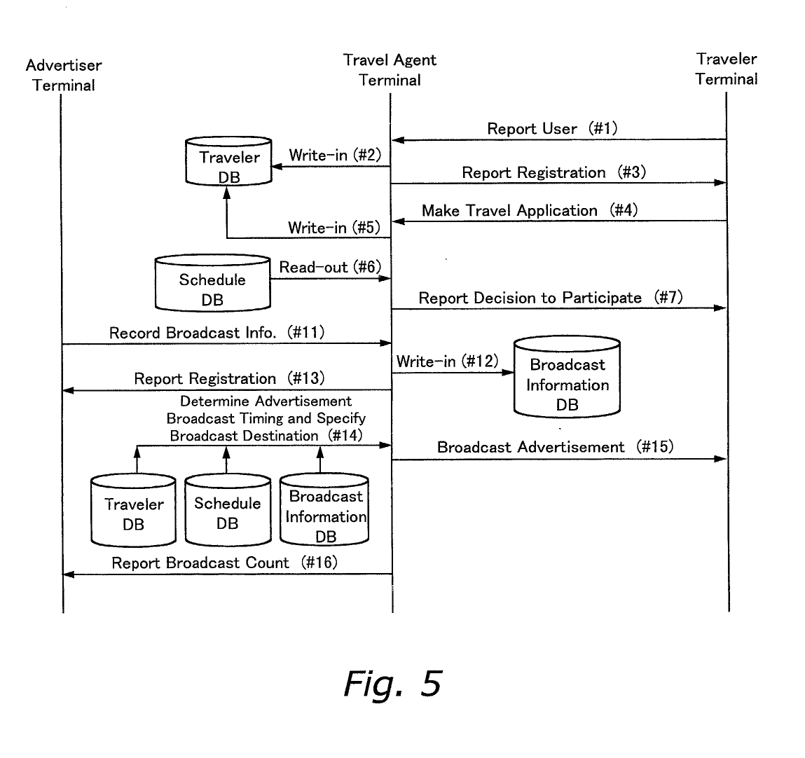

FIG. 5 is an explanatory diagram showing a process on the overall information broadcasting system. The following process is performed among the travel agent terminal 1, the traveler terminal 2, and the advertiser terminal 3.

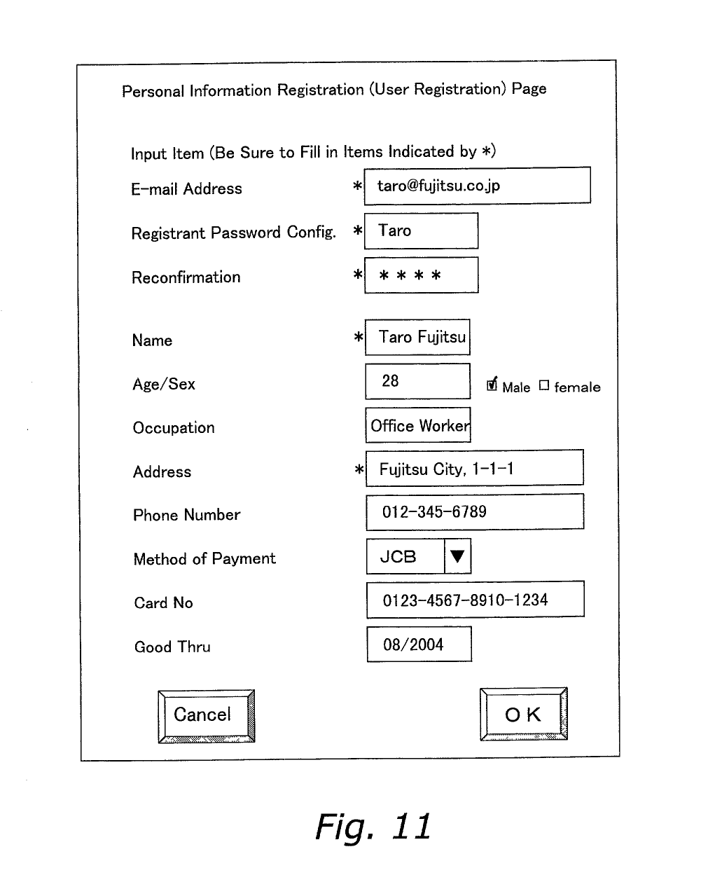

At first, a traveler accesses a homepage of a travel agency and inputs predetermined personal information in a form provided in the Web Page (refer to FIG. 11). With this, the traveler his/herself is registered in the travel agent terminal 1 (#1). On the occasion of user registration, a broadcasting destination for having advertisements broadcast is also registered. In this example, an e-mail address, which is a traveler ID, is used as a broadcasting address.

The travel agent terminal 1 that received the user information writes the inputted personal information in the traveler DB 12 and updates the traveler DB 12 (#12).

Next the travel agent terminal 1 issues registration notification to the traveler terminal 2 (#3). With this, the traveler can check if he/she was registered in the travel agent terminal 1.

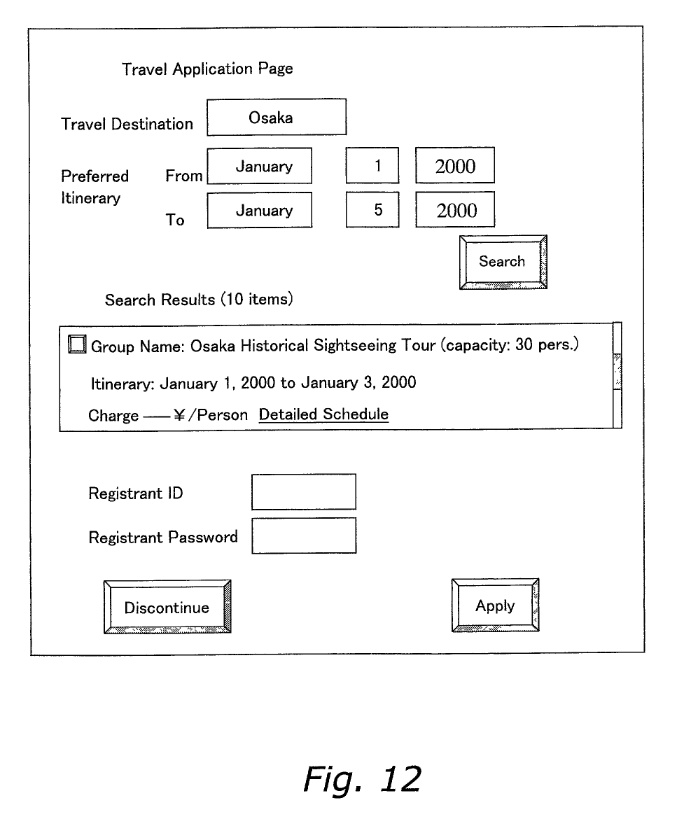

If the traveler would like to participate in a travel agency's travel plan, he or she makes travel reservations on the Web Page provided by the travel agent terminal 1 (#4) (refer to FIG. 12). The travel agent terminal 1 that received the application writes the information inputted on the Web Page in the traveler DB 12 (#5) and performs account settlement using credit card information included in the personal information. Next, the travel agent terminal 1 reads information on the reserved travel plan from the schedule DB 11 (#6). The travel agent terminal 1 notifies the traveler of the participation decision and sends a ticket and a detailed schedule (#7).

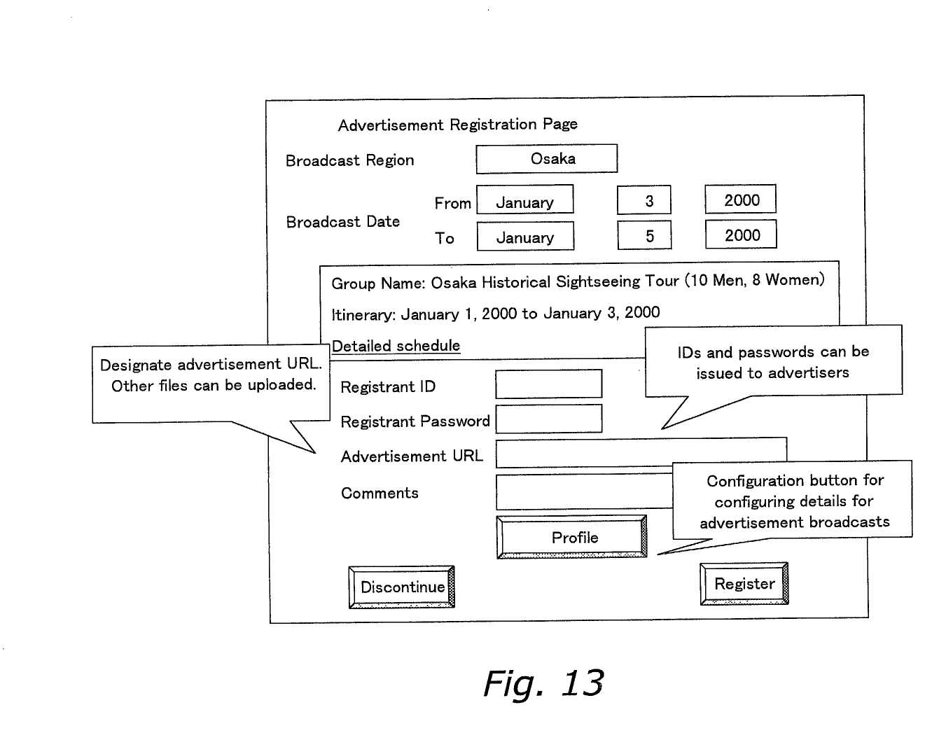

The advertiser performs the following process together with the travel agent terminal 1, independently of the foregoing processes #1 to #7. At first, the advertiser registers himself and advertisements in the travel agent terminal 1 (#11). The registration of advertisements is performed on a Web Page provided by the travel agent terminal 1 (FIG. 13). The travel agent terminal 1 writes the registered advertisements in the broadcast information DB 13 (#12) and notifies the advertiser of registration completion (#13).

The travel agent terminal 1 determines whether or not there are any advertisements to be broadcast at prescribed intervals, for example. The determined timing is to be at prescribed times, or every time a new advertisement is registered, and is not particularly limited. If there is an advertisement, the advertisement and its advertisement broadcasting destination are read from the database (#14) and the read advertisement is broadcast to the traveler terminal 2 which is a destination (#15). The above-mentioned determination whether or not there are any advertisements to be broadcast is performed by consulting the traveler DB 12, the schedule DB, and the broadcast information DB 13 and extracting a traveler with receiving conditions corresponding to the broadcasting prerequisites.

Furthermore, the travel agent terminal 1 preferably notifies the advertiser terminal 3 of the broadcast count, for example, once a day (#16). The travel agent terminal 1 also calculates billing amount according to the count of advertisement broadcasts and the broadcast data volume, for example, once a month and performs account settlement.

(3-2) Ticket Process

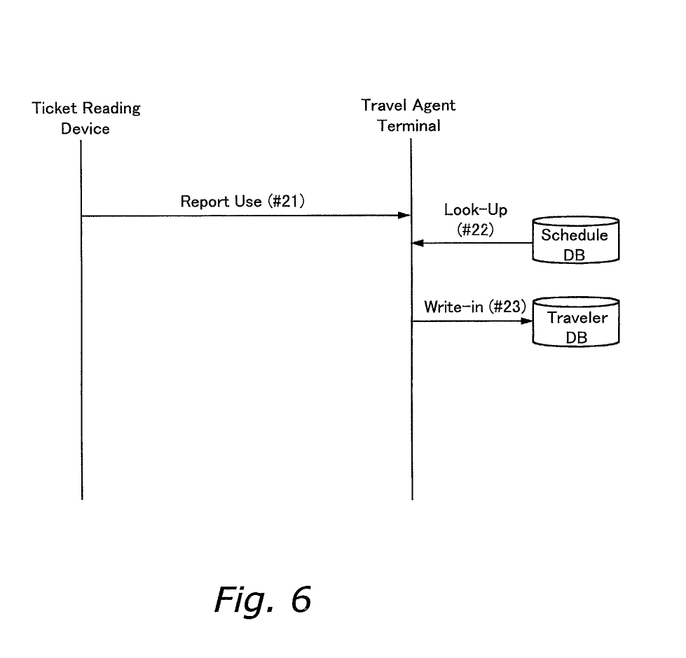

FIG. 6 is a explanatory diagram showing flow of the ticket process. The following process independent of the above-mentioned main process in FIG. 5 is performed between the ticket-reading device 4 and travel agent terminal 1.

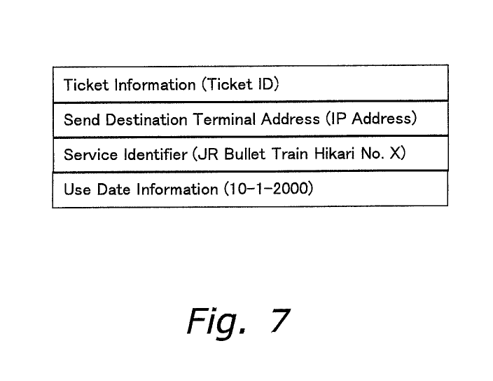

The ticket-reading device 4 sends use notification to the travel agent terminal 1 (#21). This use notification includes predetermined information for identifying tickets that have been used. FIG. 7 is an example of information included in the use notification and includes ticket information, sending destination terminal address, service identifier, and use date information.

As “ticket information,” information such as ticket ID for identifying tickets is used. As “sending destination terminal address,” an IP address of the travel agent terminal 1 can be cited. As “service identifier,” information such as the kind of ticket, e.g. JR Bullet Train Hikari No. X, is recorded. “Use date information” may be the date when the ticket-reading device 4 detected the use of the ticket.

The travel agent terminal 1 searches the schedule DB 11 for a travel plan according to which the ticket should be used (#22). Next, the travel agent terminal 1 identifies a traveler to which the used ticket is assigned from participants in the travel plan and updates the ticket status to “used” (#23).

(4) Processes on Travel Agency Terminal

In the above-mentioned FIG. 5 and FIG. 6, the travel agent terminal 1 mainly performs 1) advertisement broadcasting process, 2) substitute schedule notification process, and 3) customer information broadcasting process.

The following gives a detailed description of these three processes with figures.

(4-1) Advertisement Broadcasting Process

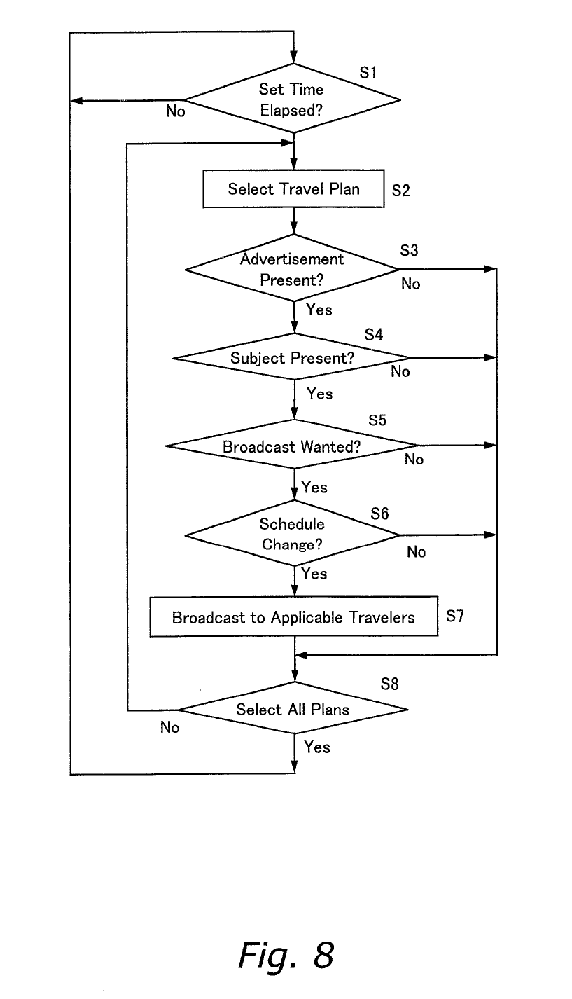

FIG. 8 is a flowchart showing flow of the advertisement broadcasting process. In the process, the travel agent terminal 1 performs a routine for broadcasting registered advertisements to travelers satisfying the broadcasting prerequisites. In this example, the determination whether or not the broadcasting prerequisites correspond to the receiving conditions is performed once a day and if so, advertisements are broadcast.

Step S1: The travel agent terminal 1 repeats the below-mentioned process at predetermined intervals, e.g. once a day.

Step S2: The travel agent terminal 1 selects from registered plans a travel plan that is performed the current day.

Steps S3 and S4: The travel agent terminal 1 refers to the broadcast information DB 13 and determines whether or not there is an advertisement that meets broadcasting prerequisites for the selected travel plan (S3). For example, if a current destination and schedule of a travel plan corresponds to a broadcasting region and broadcasting timing, it is determined that there is an advertisement.

If a broadcasting object is designated in the broadcasting prerequisites, a traveler satisfying conditions of designated objects is extracted. If it is determined that there are no advertisements, or no objects can be extracted in step S3 or S4, the below-described step S9 ensues.

Step S5: The travel agent terminal 1 determines whether or not the extracted traveler has requested broadcast of the advertisement. If so, the below-described step S9 ensues. If not, the travel agent terminal 1 refers to whether or not the type of advertisement is designated and determines an advertisement that is to be broadcast to each traveler.

Steps S6 and S7: The travel agent terminal 1 checks against each extracted traveler whether the travel plan schedule has not changed from the initial plan (S6). This is because, for example, a ticket that could have been used was not used and therefore it is expected that the traveler will not move to the scheduled place. This determination is performed by referring to the “status” of the traveler DB 12. Travelers to whom it is assumed to be useless to broadcast advertisements are deleted from the extracted travelers and step S9 ensues. To travelers with no change in their schedule, e-mail in which advertisement URLs are written is broadcast (S7).

Step S8: The travel agent terminal 1 determines whether or not the above-mentioned steps S3 to S7 have been performed concerning all travel plans performed the current day. If the result is “Yes,” the process returns to step S1 and waits for a predetermined time to elapse.

By the processes above, if the broadcasting prerequisites set by advertisers correspond to receiving conditions set by travelers, useful information in a destination is sent to a traveler's mobile phone or other on-the-go terminal. The sending mode is, for example, notifying of an advertisement URL by e-mail. On this occasion, if a message is attached indicating kind of advertisement, the traveler can refer to the advertisement by clicking the URL if he or she is interested. It should be understood that advertisements be may be made subjects for billing as having been broadcast only wherein a traveler has actually accessed an advertisement Web Page.

If an e-mail message is sent to a traveler in the above-mentioned step S7, the broadcasting address can be changed according to his destination. For example, if he is out of the mobile phone service area, broadcasting advertisements to a fax number of a previous day's lodging can be cited. The switch of a broadcasting destination may be performed by an operation on a terminal on the travel agency's end or automatically performed by the travel agent terminal 1 consulting the schedule.

(4-2) Substitute Schedule Notification Process

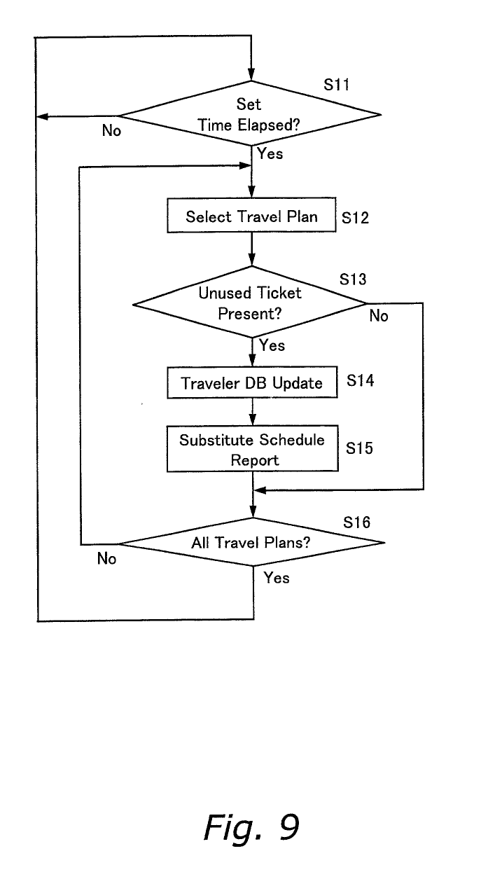

FIG. 9 is a flowchart showing flow of the substitute schedule notification process. In this process, the travel agent terminal 1 detects tickets that have not been used according to their schedule and performs a process that issues a substitute ticket to the travelers.

Step S11: The travel agent terminal 1 performs the following process at predetermined intervals, such as hourly.

Step S12: The travel agent terminal 1 refers to the schedule DB 11 and selects any of the travel plans currently performed.

Steps S13 and S14: The travel agent terminal 1 determines whether there is a ticket which has not been used according to the schedule. This determination is performed by detecting an “unused” ticket that is not used although the scheduled use time has elapsed.

If it is determined that all tickets have been used according to the schedule, the below-described step S16 ensues. If there is are tickets that have not been used according to the schedule, the ticket status is set to “cancel” and the traveler DB is updated (S14).

Step S15: The travel agent terminal 1 consults the ticket table in the schedule DB 11 and searches for a substitute ticket for the canceled ticket. Next, it notifies the relevant traveler terminal 2 of the name of the substitute ticket and information on time, place, etc. and rewrites schedule information and ticket information in the traveler DB 12. Specifically, for schedule information, travel date, place, and status on the substitute ticket are newly added and information indicating that the ticket was canceled is written in a canceled schedule entry. For ticket information, the name of the newly issued ticket and its ID are written.

Step S16: The travel agent terminal 1 determines whether or not the above-mentioned steps S12 to S15 have been performed for all the currently-performed travel plans. If the result is “Yes,” the process returns to step S1.

By performing the above-mentioned process, if a ticket has not been used although departure time for a means of transportation has passed, the ticket is automatically canceled and the vacant seat can be provided for another traveler. Notifying a traveler who could not board a prearranged means of transportation of a ticket in the nearest time bracket, serves that traveler's convenience.

(4-3) Customer Information Broadcasting Process

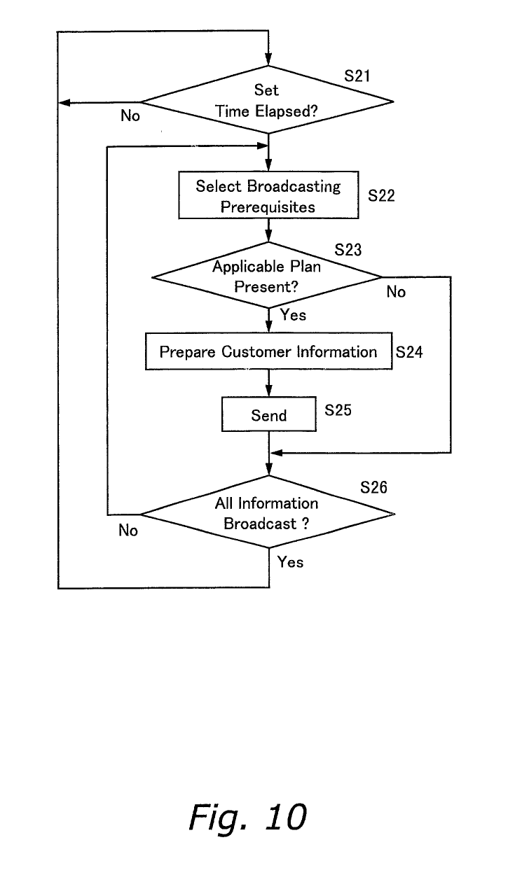

FIG. 10 is a flowchart showing flow of customer information broadcasting process. In this process, the travel agent terminal 1 sends to the advertiser by e-mail detailed information on travelers that corresponds to the broadcasting prerequisites.

Step S21: The travel agent terminal 1 performs the following steps S22 to S26 at prescribed intervals such as once a day.

Steps S22 and S23: The travel agent terminal 1 selects advertisers that register only broadcasting prerequisites from the broadcast information DB 13 (S22). Next, the travel agent terminal 1 extracts travel plans corresponding to broadcasting prerequisites from the selected advertisers (S23). If there are no corresponding plans, the process returns to the below-described step S26.

Step S24: The travel agent terminal 1 creates prescribed detailed information for travelers participating in the extracted travel plans. The information described in this detailed information is personal information on travelers who participate in travel that fits the broadcast prerequisites, and excludes information specifying travelers individually. For example, the detailed information does not include name, address, phone number, etc. Instead, the detailed information includes age, sex, hobbies, occupation, family makeup, etc.

Step S25: The travel agent terminal 1 sends created detailed information to advertisers by e-mail, for example. In this e-mail, travel plan and detailed information on participants are described.

Step S26: The travel agent terminal 1 determines whether or not the above-mentioned steps S22 to S25 have been performed. If the result is “Yes,” the process returns to step S21 and the above-mentioned steps are repeated. If the result is “No,” the above-mentioned steps are performed for a succeeding advertiser. In this manner, advertisers registering broadcasting prerequisites are notified of detailed information on travelers one after another.

With this process, advertisers can obtain more detailed information on travelers corresponding to their broadcasting prerequisites once a day, for example. Furthermore, the advertisers can create advertisements suitable to the travelers on the basis of the obtained information and therefore can perform effective marketing.

Incidentally, the method of providing the detailed information is not limited to e-mail. For example, when broadcasting prerequisites are inputted on a Web Page, the present system can be made to be display travel plans corresponding to the broadcasting prerequisites. A button for requesting detailed information provided in advance on the Web Page and if any of the displayed travel plans is selected and the button is pressed, detailed information on participants in the travel plan is displayed on the Web Page. Needles to say, various provision methods may be combined.

(5) Screen Examples

The following specifically explains screen examples displayed in the traveler terminal 2 and the advertiser terminal 3.

(5-1) User Registration Screen

FIG. 11 is an example of an input form for travelers to register themselves in the travel agent terminal 1. For example, if the form is provided on a Web Page, personal information can be registered only with a browser in the traveler terminal 2. A traveler inputs information such as name, age, and sex and account settlement information necessary for payment when the traveler participates in a travel plan in addition to an e-mail address necessary to broadcast advertisements afterwards. Essential information that must be input, which includes an e-mail address, is indicated by the mark *.

(5-2) Travel Reservation Screen

FIG. 12 is an example of a screen by which travelers may apply for a travel plan. In this example, designating travel destination and term displays relevant travel plans in the window. Checking a preferable travel plan and pressing the application button allows the travel plan to be applied for.

(5-3) Advertisement Registration Screen

FIG. 13 is an example of a form for advertisers to register broadcasting prerequisites and advertisements. By providing the form on a Web Page, advertisers can register advertisements with a browser only. In this example, broadcasting region and broadcasting date are designated as broadcasting prerequisites. Inputting the information displays a travel plan satisfying the broadcasting prerequisites. Selecting “detailed schedule” now displays the schedule of the travel plan.

By inputting a registrant ID and a registrant password, inputting a URL specifying an advertisement and file name, etc., and pressing the registration button, broadcasting of advertisements broadcasting prerequisites are designated to can be requested from travel agencies.

Furthermore, by pressing the “detailed setting button,” conditions of objects for broadcasting advertisements can be set in detail.

(5-4) Screen for Detailed Setting of Broadcasting Prerequisites

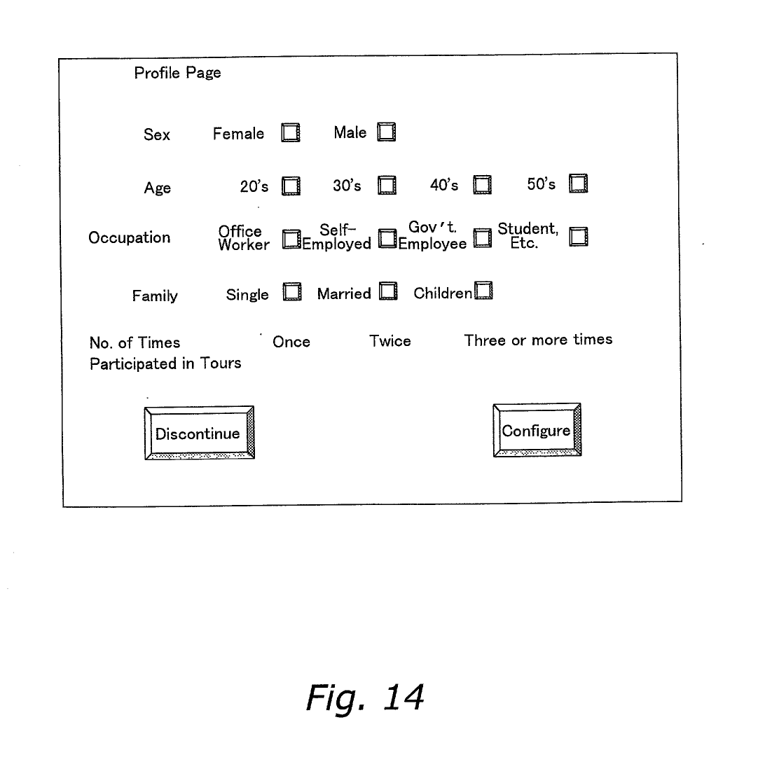

FIG. 14 is an example of a screen for performing a detailed setting of broadcasting prerequisites. In this example, in addition to region and date, sex, age, occupation, family makeup, count of tour participation times is set as one of the broadcasting prerequisites. A plurality of the prerequisite details can be designated.

(5-5) Advertisement Screen

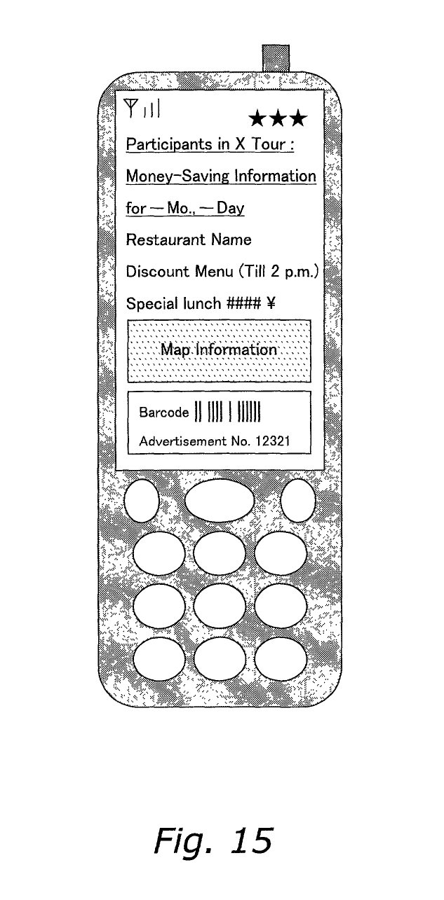

FIG. 15 is an example wherein an advertisement is displayed on a traveler's mobile terminal. By accessing a URL notified by e-mail, the traveler can browse an advertisement screen as shown in the figure. In this screen, the number of “*” marks indicates recommendation level set by travel agents. As advertisement information, map information is placed in addition to restaurant name, discount menu, and money-saving items. To facilitate discount, a barcode is displayed and reading the barcode at a register makes discount process at a register easier. The displayed advertisement number is granted by the travel agency and is for facilitating response to inquiries about advertisements.

### Other Embodiments

(A) In the above-mentioned embodiment, advertisements are broadcast to travelers with receiving conditions corresponding to broadcasting prerequisites. However, the broadcasting of advertisements can be adjusted to current timing according to a travel schedule.

For example, advertisements may be broadcast to a traveler with receiving conditions being expected to correspond to broadcasting prerequisites. In other words, advertisements about a destination may be broadcast to a traveler before travel departure or a traveler before arrival at a destination. This is because the traveler is thought to want information on his destination in advance to draw up a plan about the destination.

Specifically, if broadcasting prerequisites are expected to be satisfied by executing a travel plan, advertisements are broadcast one week before the departure. Needless to say, this advertisement broadcasting day may not be one week before the departure and may be set to an appropriate term according to traveler's needs. For example, advertisements about a tomorrow's destination may be sent a day before the moving day.

(B) A recording medium recording a program for executing the above-mentioned methods of the present invention is included in the present invention. Herein the recording medium can be a floppy disk, hard disk, semiconductor memory, CD-ROM, DVD, MO, etc.

Use of the present invention reduces the burden of analyzing use histories of services provided on a network, and user behavior to be easily predicted from commodities purchased on the network. The predicted result is effectively used by third parties for marketing.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments set forth in the present invention is provided for illustration only, and not for the purpose of limiting the invention as defined by the appended claims and their equivalents.

What is claimed is:

1. An information broadcasting method characterized by:
consulting a given person's itinerary; and
automatically broadcasting to an information terminal for said given person pre-registered advertising information or reference information in connection with dates and times, and/or places appropriate to the itinerary.

2. An information broadcasting method for broadcasting, from an information-provision service device, to travelers information in connection with travel destinations, the information broadcasting method:
registering in the information-provision service device communications addresses for the travelers and travel schedules in which the travelers participate;
registering in the information-provision service device relevant information in connection with to-be-visited travel destinations in the travel schedule, as well as broadcasting prerequisites for broadcasting the relevant information; and
matching the broadcasting prerequisites for the relevant information with the travel schedule, extracting travelers who meet the broadcasting prerequisites, and broadcasting the relevant information to the extracted travelers' communications addresses according to progress of the travel schedule.

3. An information broadcasting method for broadcasting, from travel service providers, to travelers information in connection with travel destinations, the information broadcasting method:
storing communications addresses for the travelers, travel plans in which the travelers participate, and travel-plan schedules;
providing travel-plan schedules to third parties other than the travel service providers or the travelers;
accepting from the third parties relevant information in connection with to-be-visited travel destinations in the travel plan, as well as broadcasting prerequisites for broadcasting the relevant information;
extracting based on the foregoing stored information travelers who meet the broadcasting prerequisites and/or travelers anticipated to meet the broadcasting prerequisites; and
broadcasting at predetermined timings said relevant information to the communications addresses for the extracted travelers.

4. An information broadcasting method according to claim 3, wherein:
predetermined personal information is stored correlatively with the communications addresses; and
if the broadcasting prerequisites have been designated preceding registration of said relevant information, predetermined detailed information, wherein information for specifying travelers is excluded from the personal information for travelers anticipated to meet the broadcasting prerequisites, is provided to the third parties.

5. An information broadcasting method according to claim 3, wherein said communications addresses are changed according to the travel-plan schedules.

6. An information broadcasting method according to claim 3, wherein:
receiving-condition designations including need for broadcast of the relevant information, and/or type of relevant information to be broadcast is accepted from the travelers; and
if the receiving conditions and the broadcast prerequisites match, the relevant information is broadcast.

7. An information broadcasting method according to claim 3, wherein the third parties are billed according to broadcast count for the relevant information and/or amount of data broadcast.

8. An information broadcasting method according to claim 3, wherein:
use of predetermined tickets while the travel plans are under way is sensed, and
modifications to the travel-plan schedules are detected based on tracking use of the tickets.

9. An information broadcasting method according to claim 8, wherein travelers meeting the broadcasting prerequisites and/or travelers anticipated to meet the broadcasting prerequisites are extracted based on the modified travel-plan schedules.

10. An information broadcasting device for broadcasting, from a travel service provider, to travelers information in connection with travel destinations, the information broadcasting device comprising:
storage means for correlatively storing communications addresses for the travelers, travel plans in which the travelers participate, and travel-plan schedules;
provision means for providing travel-plan schedules to third parties other than the travel service providers or the travelers;
acceptance means for accepting from third parties relevant information in connection with to-be-visited travel destinations in the travel plan, as well as broadcasting prerequisites for broadcasting the relevant information;
extraction means for extracting based on the foregoing stored information travelers who meet the broadcasting prerequisites and/or travelers anticipated to meet the broadcasting prerequisites; and
broadcasting means for broadcasting at predetermined timings said relevant information to the communications addresses for the extracted travelers.

11. An information broadcasting method for broadcasting, from travel service providers, to travelers information in connection with travel destinations, the information broadcasting method:
correlatively storing communications addresses for the travelers, travel plans in which the travelers participate, and travel-plan schedules;
providing the travel-plan schedules to third parties;
accepting from third parties advertisement designations for travelers participating in the travel plans;
broadcasting at predetermined timings the advertisements to communications addresses for the travelers participating in the travel plans.

12. A computer-readable recording medium on which is recorded a program for executing an advertisement broadcasting method used in an advertisement provision device connected via a network to a plurality of user terminals, a plurality of advertiser terminals, and a plurality of travel agency terminals, the program recorded on a recording medium executing:
a process for providing to user terminals or travel agency terminals a screen for inputting information in connection with travel reservations and/or information in connection with receiving conditions for advertisement information;
a process for correlatively storing in a storage device users, travel schedules, and advertisement receiving conditions, based reservation information sent from user terminals or travel agency terminals;
a process for providing to the advertiser terminals a screen for inputting advertising data broadcast to travelers and broadcasting prerequisites;
a process for storing in a storage device advertising data broadcast to travelers and broadcasting prerequisites, sent from advertiser terminals;
a process for comparing travelers, receiving conditions with advertisement broadcasting prerequisites and specifying matching travelers; and
sending appropriate advertising data to the specified travelers.
